(19) United States
(12) Patent Application Publication
(10) Pub. No.: US 2023/0181937 A1
(43) Pub. Date: Jun. 15, 2023

(54) HEADGEAR HAVING AN AIR PURIFIER

(71) Applicant: Dyson Technology Limited, Wiltshire (GB)

(72) Inventors: Philip Stephen DARLING, Bristol (GB); Christopher Ralph MENZIES-WILSON, Gloucester (GB); Stephen Benjamin COURTNEY, Gloucester (GB)

(73) Assignee: Dyson Technology Limited, Wiltshire (GB)

(21) Appl. No.: 17/923,530

(22) PCT Filed: May 5, 2021
(86) PCT No.: PCT/GB2021/051085

§ 371 Date: Nov. 4, 2022

(30) Foreign Application Priority Data
May 26, 2020 (GB) 2007812.7

(51) Int. Cl. A62B 18/00; A62B 7/10; A62B 18/08

(52) U.S. Cl. CPC A62B 18/003; A62B 7/10; A62B 18/08

(57) ABSTRACT

A headgear is described that includes a first air purifier, a second air purifier, a first microphone, a second microphone, and a control unit. The control unit analyses a first signal output by the first microphone and a second signal output by the second microphone to determine a direction of wind. The control unit then controls the relative flow rates of the first air purifier and the second air purifier in response to the determined direction of wind.

### FIELD OF THE INVENTION

The present invention relates to a headgear having an air purifier.

### BACKGROUND OF THE INVENTION

Pollutants in the air can be harmful to human health. Air purification devices are known that remove pollutants from the air and direct a stream of purified air towards the mouth and nose of the wearer. A potential problem with such devices is that, when worn outdoors, wind may push the stream of purified air away from the mouth and nose of the wearer.

### SUMMARY OF THE INVENTION

The present invention provides a headgear comprising an air purifier, a first microphone, a second microphone, and a control unit, wherein the control unit analyses a first signal output by the first microphone and a second signal output by the second microphone to determine a direction of wind, and the control unit controls a flow rate of the air purifier in response to the determined direction of wind.

With the headgear of the present invention, the flow rate of the air purifier is controlled in response to the direction of wind. For example, a higher flow rate may be used in response to a crosswind, and a lower flow rate may be used in response to a headwind and/or tailwind. Crosswinds may push the purified air away from the mouth and nose of the wearer. By increasing the flow rate in response to a crosswind, a stronger stream of purified air may be generated and thus deviations in the direction of the stream may be reduced.

The control unit determines the direction of wind based on signals output by microphones. Microphones typically sense air disturbances in the range of hundreds of µPa up to tens of Pa. However, even relatively weak wind can generate pressures that a hundred times greater than this. The headgear therefore exploits these characteristics to provide a relatively cost-effective solution for detecting the direction of wind.

The headgear may comprise a further air purifier and the control unit may control the relative flow rates of the air purifier and the further air purifier in response to the determined direction of wind. By controlling the relative flow rates of two air purifiers, greater control may be achieved over the direction of the purified air directed at the wearer. For example, in a response to a crosswind from the left, the relative flow rate of one of the air purifiers may be increased, and in response to a crosswind from the right, the relative flow rate of the other of the air purifiers may be increased.

The air purifier may be located on a first side of the headgear, and the further air purifier may be located on a second opposite side of the headgear. The control unit, in response to determining that the direction of wind is from a side of the headgear, may increase the relative flow rate of the air purifier located on the opposite, downstream side of the headgear. As a result, a stronger stream of purified air may be generated in a direction that opposes the wind, and thus the resultant stream of purified air may be better targeted at the mouth and nose of the wearer.

The air purifier may generate a first flow of purified air, and the further air purifier may generate a second flow of purified air. Moreover, the first flow and the second flow may combine to generate a combined flow of purified air, the direction of which is defined by the relative flow rates of the air purifier and the further air purifier. The control unit is therefore able to control the relative flow rates of the purifiers in order to control the direction of the combined flow of purified air. Accordingly, in response to a crosswind, the control unit may control the relative flow rates such that the combined flow of air is nevertheless directed towards the mouth and nose of the wearer.

The control unit may determine the direction of wind based on differences in the first signal and the second signal. At relatively low frequencies, where the majority of the energy from wind is contained, real-life noises are likely to generate similar patterns in the signals of the two microphones. However, when wind particles impact the diaphragms of the two microphones, they may do so in a random way that is unique to each microphone. As a result, wind is likely to manifest itself as different patterns in the two signals. Accordingly, by analysing differences in the two signals, the direction of wind may be determined.

The control unit may transform time samples of the first signal into one or more first frequency samples, transform time samples of the second signal into one or more second frequency samples, and determine the direction of wind based on energies of the first frequency samples and the second frequency samples. When air particles hit the diaphragms of the microphones, they do so in an unpredictable way. Nevertheless, the wind has a recognisable shape in the frequency domain. Accordingly, by transforming samples of the two signals from the time domain to the frequency domain, and then analysing the energies of the frequency samples, the direction of wind may be determined.

The control unit may determine the direction of wind based on differences in the energies of the first frequency samples and the second frequency samples. As already noted, at relatively low frequencies, real-life noises are likely to have similar energies in the signals of the two microphones. By contrast, wind is likely to manifest itself as different energies in the two signals. Accordingly, by analysing differences in the energises of the frequency samples of the two signals, the direction of wind may be determined.

The control unit may determine the direction of wind based on variations in the differences with time. Some real-life noises may have energies at lower frequencies, and may therefore be mistaken for wind. The energy associated with wind may vary significantly with time. By contrast, the energy associated with a real-life noise may vary comparatively little over the same time period. Accordingly, the magnitude of wind may be determined by analysing temporal variations in the energies of the frequency samples.

The control unit may determine a coherence of the first signal and the second signal, and determine the direction of wind based on the coherence. Coherence is a measure of the relationship between the two microphone signals, and may therefore be used to evaluate similarity. As noted, at relatively low frequencies, where the majority of the energy from wind is contained, real-life noise is likely to have a similar energy signature (albeit at potentially different amplitudes) in each of the microphone signals. By contrast, wind is likely to have a different energy signature in the two signals. Accordingly, the coherence of the two signals may provide a relatively good measure of the presence and direction of wind.

The control unit may transform time samples of the first signal into one or more first frequency samples, transform time samples of the second signal into one or more second frequency samples and determine the direction of wind based on at least two of: the energies of the first frequency samples and/or the second frequency samples; variations in the energies of the first frequency samples and/or the second frequency samples with time; differences in the energies of the first frequency samples and the second frequency samples; and variations in the differences in the energies of the first frequency samples and the second frequency samples. By using at least two different measures, a more reliable determination of the direction of wind may be made.

The control unit may analyse the first signal and the second signal to determine a magnitude of wind. The control unit may then control the flow rate of the air purifier in response to the determined magnitude of wind and the determined direction of wind. By controlling the flow rate of the air purifier in response to both the direction and the magnitude of the wind, greater control may be achieved over the direction of the purified air directed at the wearer.

The control unit may transforms time samples of the first signal into one or more first frequency samples, transform time samples of the second signal into one or more second frequency samples, and determines the magnitude of wind and the direction of wind based on energies of the first frequency samples and the second frequency samples. As already noted, wind has a recognisable shape in the frequency domain. Accordingly, by transforming samples of the two signals from the time domain to the frequency domain, and then analysing the energies of the frequency samples, both the magnitude and the direction of wind may be determined.

The headgear may comprise a further air purifier and the control unit may control the relative flow rates of the air purifier and the further air purifier in response to the determined magnitude of wind and the determined direction of wind. By controlling the relative flow rates of two air purifiers, in response to both the direction and magnitude of the wind, greater control may be achieved over the direction of the purified air directed at the wearer. For example, in a response to a crosswind from the left, the relative flow rate of one of the air purifiers may be increased, and in response to a crosswind from the right, the relative flow rate of the other of the air purifiers may be increased. Moreover, the amount by which the relative flow rate is increased may depend on the magnitude of the wind. As a result, purified air may be better targeted at the wearer over a range of different wind conditions.

The air purifier may be located on a first side of the headgear, and the further air purifier may be located on a second, opposite side of the headgear. The control unit, in response to determining that the direction of wind is from a side of the headgear, may increase the relative flow rate of the air purifier located on the opposite, downstream side of the headgear by an amount defined by the magnitude of the wind. As a result, a stream of purified air may be generated in a direction that opposes the wind. Moreover, the strength of the purified air may be greater when the wind is stronger (i.e. when the magnitude is greater). As a result, the resultant stream of purified air may be better targeted at the mouth and nose of the wearer.

The headgear may comprise a left ear cup and a right ear cup, and the left ear cup may comprise the first microphone, and the right ear cup may comprise the second microphone. By locating the microphones in opposite ear cups, differences in the signals of the two microphones may be used to determine the direction of wind.

Each ear cup may comprise a speaker and an active noise cancellation unit. The active noise cancellation unit of the left ear cup may comprise the first microphone, and the active noise cancellation of the right ear cup may comprise the second microphone. As a result, a cost-effective solution is provided for controlling the flow rate of the air purifier in response to the direction of wind. In particular, the microphones may be used for two very different purposes.

The headgear may comprises a third microphone and a fourth microphone, and the control unit may analyse signals output by the four microphones to determine the direction of wind. The first and second microphones may be feedforward microphones and the third and fourth microphones may be feedback microphones. As a result, a cost-effective solution is provided for controlling the flow rate of the air purifier in response to wind. This arrangement has the further advantage that the feedback microphones are isolated or shielded from the wind. As a result, incoherence or other differences between the signals of the feedforward and feedback microphones due to wind will be amplified and thus a more reliable determination of the direction of wind may be made.

### BRIEF DESCRIPTION OF THE DRAWINGS

Embodiments will now be described, by way of example, with reference to the accompanying drawings in which:

FIG. 1 illustrates a headgear in accordance with an embodiment;

FIG. 2 is a simplified illustration of a section through the headgear;

FIG. 3 illustrates an ear cup of the headgear;

FIG. 4 is a section through the ear cup;

FIG. 5 illustrates a nozzle of the headgear;

FIG. 6 is a block diagram of components of the headgear;

FIG. 7 is a block diagram of a wind detect module of the headgear; and

FIG. 8 illustrates the frequency response of five microphones, only one of which (indicated by an arrow) was exposed to wind.

### DETAILED DESCRIPTION OF THE INVENTION

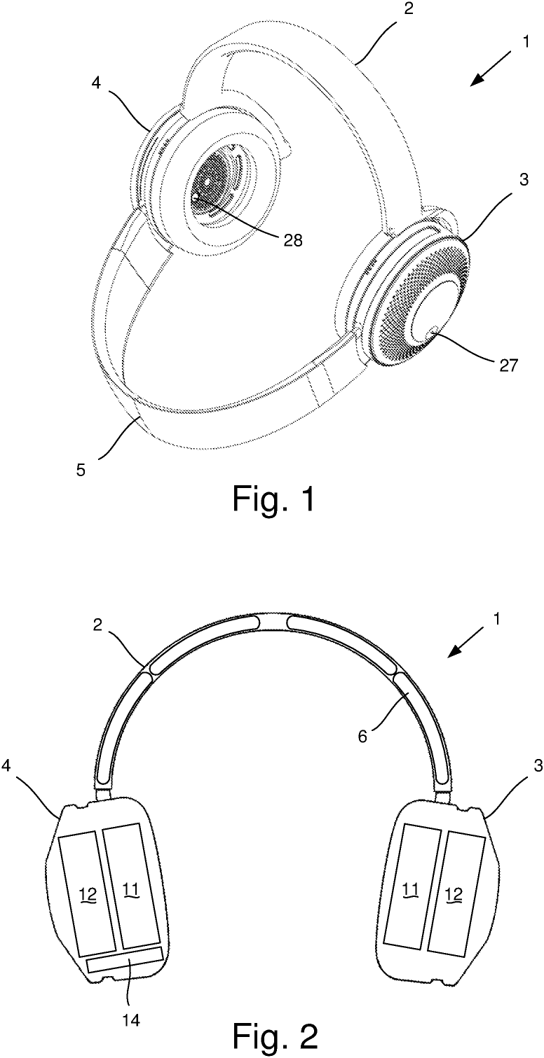

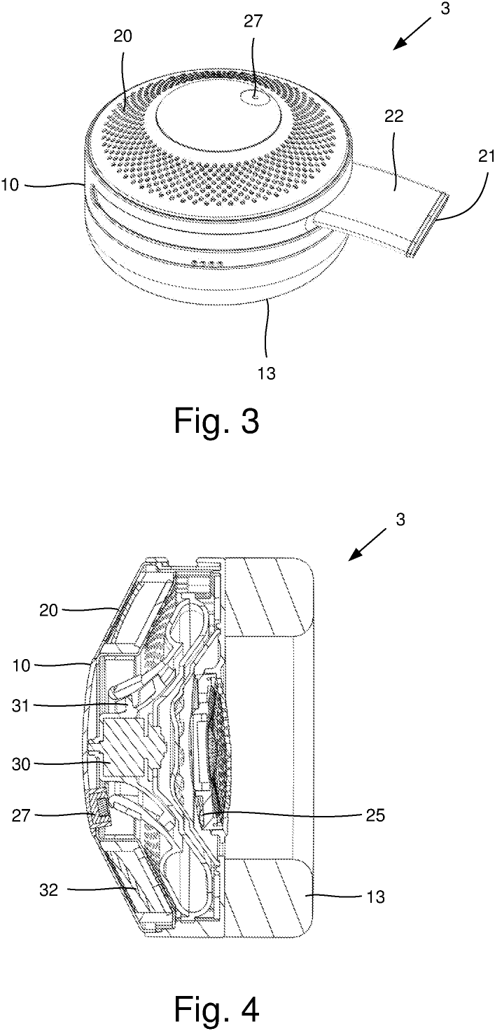

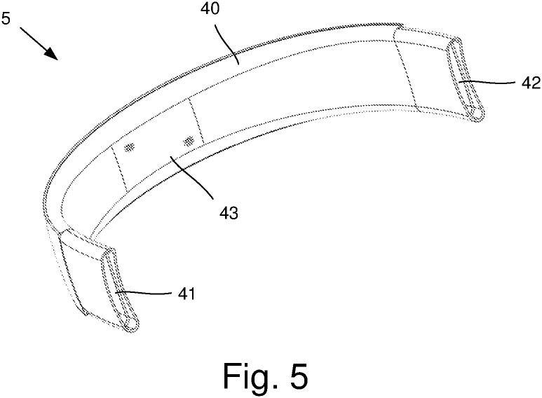

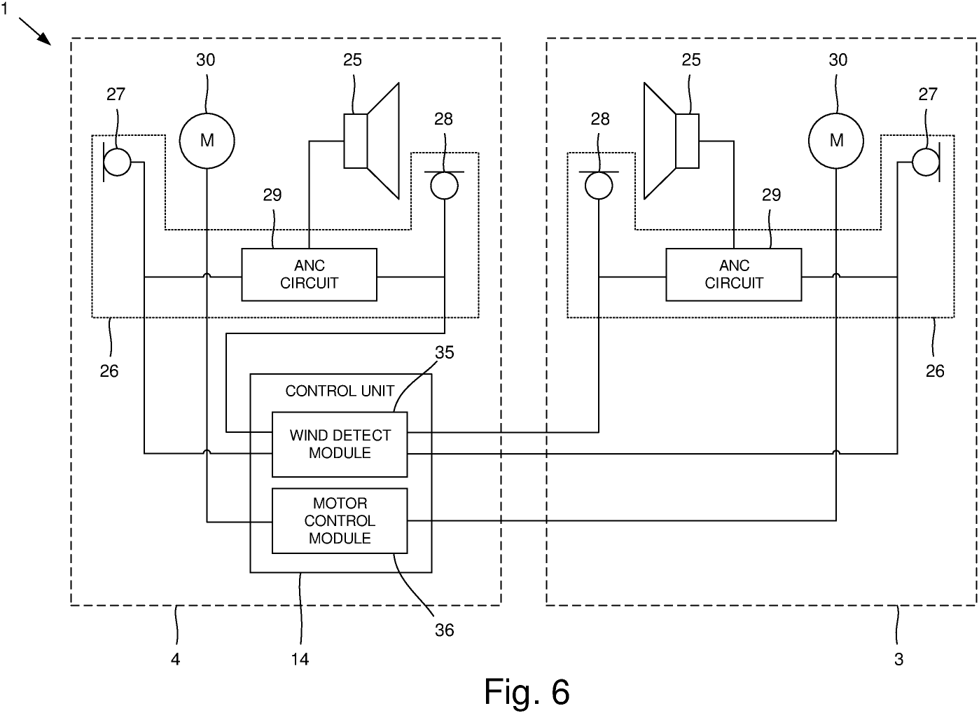

The headgear 1 of FIGS. 1 to 6 comprises a headband 2, a left ear cup 3, a right ear cup 4 and a nozzle 5.

The headband 2 is attached at one end to the left ear cup 3, and at the opposite end to the right ear cup 4. The headband 2 house one or more batteries 6 for powering electrical components of the ear cups 3,4.

Each ear cup 3,4 comprises a housing 10, a speaker assembly 11, an air purifier 12, and an ear pad 13. Additionally, one of the ear cups 3,4 comprises a control unit 14.

The housing 10 houses the speaker assembly 11, the air purifier 12 and (for one of the ear cups) the control unit 14, and comprises an air inlet 20 and an air outlet 21. The air inlet 20 comprises a plurality of apertures in a wall of the housing 10. The air outlet 21 is provided at the end of an outlet duct 22 of the housing 10.

The speaker assembly 11 comprises a speaker 25 and an active noise cancellation (ANC) unit 26. The ANC unit 26 comprises a feedforward microphone 27, a feedback microphone 28 and an ANC circuit 29. The ANC circuit 29 is coupled to the feedforward 27 and feedback microphones 28, and to the speaker 25. In response to signals received from the feedforward and feedback microphones 27,28, the ANC circuit 29 generates an output signal for driving the speaker 25.

The air purifier 12 comprises an electric motor 30, an impeller 31 and a filter 32. The impeller 31 is driven by the electric motor 30 and, when driven, causes air to drawn in through the air inlet 20 of the housing 10. The air is drawn through the filter 32, which is located upstream of the impeller 31. The air is purified by the filter 32, and the purified air is discharged via the air outlet 21 of the housing 10.

The control unit 14 comprises a wind detect module 35 and a motor control module 36.

The wind detect module 35 is coupled to the feedforward and feedback microphones 27,28 of both ear cups 3,4. The wind detect module 35 analyses the signals output by the microphones 27,28 to determine a magnitude and/or a direction of wind.

The motor control module 36 controls the electric motor 30 of each ear cup 3,4. More specifically, the motor control module 36 generates drive signals (e.g. PWM signals) for controlling the speeds of the electric motors 30 and thus the flow rates of the air purifiers 12. The motor control module 36 is coupled to the wind detect module 35. In response to the magnitude and/or direction of the wind determined by the wind detect module 35, the motor control module 36 controls the flow rates of the air purifiers 12.

The nozzle 5 is releasably attached to the left and right ear cups 3,4. More specifically, the nozzle 5 is releasably attached to the outlet ducts 22 of the left and right ear cups 3,4. The nozzle 5 comprises a curved duct 40 having a first inlet 41 located at one end of the duct 40, a second inlet 42 located at an opposite end of the duct 40, and an outlet 43 located midway along the length of the duct 40. The outlet 43 comprises an aperture in the duct 40 covered by mesh. When attached to the ear cups 3,4, the first inlet 41 of the nozzle 5 receives a first airflow from the air purifier 12 of the left ear cup 3, and the second inlet 42 receives a second airflow from the air purifier 12 of the right ear cup 4. The two airflows travel within the duct 40 and combine at the outlet 43. The combined airflow is then discharged from the nozzle 5 via the outlet 43.

When the headgear 1 is worn by a wearer, the combined airflow of the two air purifiers 12 is discharged as a stream of purified air towards the mouth and nose of the wearer. When the headgear 1 is worn outdoors, wind may push the stream of purified air away from the mouth and nose of the wearer. In order to compensate for this, the control unit 14 controls the flow rates of the air purifiers 12 in response to changes in the wind.

The wind detect module 35 analyses the signals output by the microphones 27,28 of the headgear 1 and, in response, determines a magnitude and/or a direction of the wind. The analysis performed by the wind detect module 35 is described below in more detail. In response to the determined magnitude and/or direction, the motor control unit 36 controls the flow rate of the air purifiers 12.

In a first example, the wind detect module 36 may determine a magnitude of wind. More particularly, the wind detect module 35 may determine that the magnitude of the wind is either low or high. When the magnitude of the wind is low, the motor control unit 36 drives the electric motors 30 of the air purifiers 12 at a first speed such that each air purifier 12 generates purified air at a first flow rate. The airflows of the two air purifiers 12 combine at the outlet 43 of the nozzle 5 to generate a stream of purified air that is directed towards the mouth and nose of the wearer at a first velocity. When the wind detect module 35 determines that the magnitude of wind is high, the motor control unit 36 drives the electric motors 30 of the air purifiers 12 at a second, higher speed such that each air purifier 12 generates purified air at a second, higher flow rate. As a result, a stream of purified air is directed towards the mouth and nose of the wearer at a second, higher velocity. Consequently, in response to an increase in the magnitude of the wind, the velocity of the stream of purified air is increased. Deviations in the direction of the stream due to the wind are thus reduced, and therefore purified air continues to be maintained at the mouth and nose of the wearer.

In a second example, the wind detect module 35 may determine a direction of wind. More particularly, the wind detect module 35 may determine that the direction of the wind is from the left, from the right, or from the front/rear relative to the headgear 1.

When the direction of wind is from the left, the motor control unit 36 drives the electric motor 30 of the air purifier 12 of the right ear cup 4 at a higher speed than that of the left ear cup 3. This may be achieved by increasing the speed of the electric motor 30 of the right ear cup 4 and/or by decreasing the speed of the electric motor 30 of the left ear cup 3. As a result of the different speeds, the air purifier 12 of the right ear cup 4 generates purified air at a higher flow rate than that of the air purifier 12 of the left ear cup 3. The two airflows continue to combine at the outlet 43 of the nozzle 5. However, because the two airflows have different flow rates, the stream of purified air discharged from the outlet 43 is no longer directed straight ahead but is instead skewed to one side. In this particular instance, the air purifier 12 of the right ear cup 4 generates a higher flow rate. As a result, the stream of purified air is skewed to the left. The stream of purified air is therefore skewed in a direction that opposes the wind. The resultant stream of purified air (i.e. the resultant of the stream discharged from the nozzle and the wind) arrives at the mouth and nose of the wearer.

When the direction of wind is from the right, the motor control unit 36 drives the electric motor 30 of the left ear cup 3 at a higher relative speed. As a result, the air purifier 12 of the left ear cup 3 generates a higher flow rate and thus the stream of purified air is skewed to the right. When the direction of wind is from the front or rear, the motor control unit 36 drives the electric motors 30 of both air purifiers 12 at the same speed. As a result, the air purifiers 12 generate purified air at the same flow rates and thus the stream of purified air is directed straight ahead.

The control unit 14 therefore controls the relative flow rates of the air purifiers 12 in response to the determined direction of the wind. More specifically, in response to determining that the direction of wind is from a side of the headgear 1, the control unit 14 increases the relative flow rate of the air purifier 12 located on the downstream side of the headgear 1. As a result, a stream of purified air is discharged from the nozzle 5 in a direction that opposes the wind, and thus the resultant stream of purified air arrives at the mouth and nose of the wearer.

In the first example described above, the wind detect module 35 determines whether the magnitude of wind is low or high. It will be appreciated that the wind detect module 35 may use other scales when determining the magnitude of wind. For example, the wind detect module 35 may determine that the magnitude of wind has a value of between 0 and 10, where 0 is no wind and 10 is high wind. Similarly, in the second example, the wind detect module 35 determines whether the magnitude of wind is from the left, the right, or the front/back. Again, the wind detect module 35 may use other scales when determining the direction of wind. For example, the wind detect module 35 may determine that the direction of wind has a value of between -10 to +10, where -10 is a crosswind directly from the left, +10 is a crosswind directly from the right, and 0 is a headwind or tailwind.

The wind detect module 35 may determine both the magnitude of wind and the direction of wind. In this instance, the motor control unit 36 controls the relative flow rates of the air purifiers 12 in response to both the magnitude and the direction of the wind.

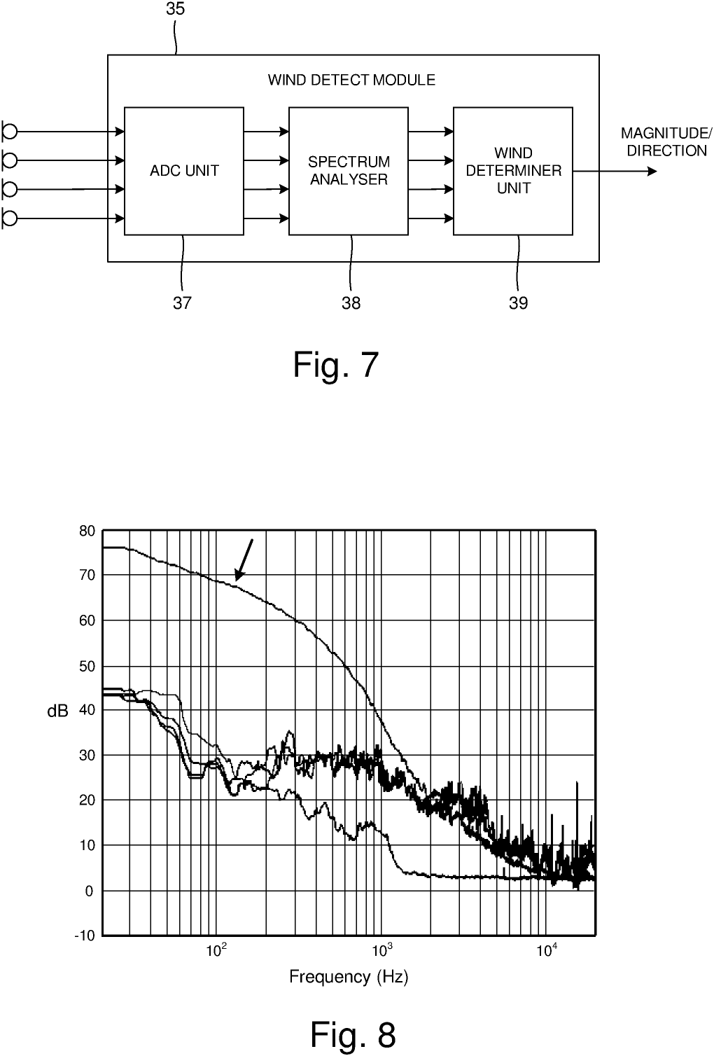

Referring now to FIG. 7, the wind detect module 35 comprises an analogue-to-digital converter (ADC) unit 37, a spectrum analyser 38, and a wind determiner unit 39. The ADC 37 unit converts the signals of the four microphones 27,28 from analogue to digital. The spectrum analyser 38 transforms each of the digital microphone signals from the time domain to the frequency domain. The spectrum analyser 38 uses a fast Fourier transform (FFT) or other discrete Fourier transform in order to transform time-domain samples of the microphone signal into frequency-domain samples (sometimes referred to as bins). Each frequency sample represents the amount of energy that the microphone signal has at that particular frequency. The wind determiner unit 39 analyses the energies of the frequency samples and, in response, determines a magnitude of wind and/or a direction of wind.

The microphones 27,28 of the headgear 1 are designed to sense air disturbances in the range of hundreds of µPa up to tens of Pa. However, even weak wind (e.g. 1 on the Beaufort scale) can generate pressures that a hundred times greater than this. The wind detect module 35 therefore uses the microphones 27,28 as sensitive pressure sensors for sensing the magnitude and/or direction of wind.

When air particles hit the diaphragm of a microphone they do so in an unpredictable way. Nevertheless, the wind has a recognisable shape in the frequency domain. FIG. 8 is a time-averaged plot of the frequency response of five microphones, only one of which (indicated by an arrow) was exposed to wind. The shape or energy of the microphone signal varies with frequency and depends on, among other things, the position of the microphone, the housing and surrounding structures of the ear cup, as well as the magnitude and direction of the wind. Nevertheless, changes in the shape of the signal due to wind occur predominantly at low frequencies and usually the majority of the energy is contained at frequencies below about 500 Hz. The wind detect module 35 exploits this behaviour in order to determine the magnitude and/or direction of the wind.

As described below, there are various methods which the wind detect module 35 may employ to determine the magnitude and/or direction of the wind. Although the headgear 1 comprises four microphones (two microphones 27,28 in each ear cup 3,4), some of the methods employed by the wind detect module 35 may be implemented using fewer microphones. Indeed, some of the methods may be implemented using just one microphone.

In each of the methods described below, the wind detect module 35 analyses the microphone signals and determines a magnitude and/or direction of wind based on the energies of the signals over a predefined frequency range. As noted above, the majority of the energy of the wind is contained at frequencies below about 500 Hz. Many real-life noises may have energies at these frequencies. However, very few real-life noises have significant energies at frequencies below about 50 Hz. Accordingly, the predefined frequency range employed by the wind detect module 35 may be, for example, 0 to 50 Hz. As a result, the magnitude and/or direction of wind may be determined more reliably with fewer false triggers.

The spectral analyser 38 may use a sampling frequency such that a single frequency sample is generated that spans the predefined frequency range. Alternatively, the spectral analyser 38 may use a sampling frequency such that a plurality of frequency samples are generated that span the predefined frequency range. The spectral analyser 38 may therefore be said to generate one or more frequency samples that span the predefined frequency range.

In a first method, the wind detect module 35 determines a magnitude of wind using just one of the feedforward microphones 27.

The wind determiner unit 39 determines the magnitude of wind based on the total energy of the one or more frequency samples. More particularly, the wind determiner unit 39 compares the total energy of the samples against one or more thresholds, and determines the magnitude of wind based on the comparison. For example, the wind determiner unit 39 may compare the total energy of the samples against a single threshold. The wind determiner unit 39 then determines that the magnitude of wind is low if the total energy is less than the threshold, and high if the total energy is greater than the threshold.

The wind determiner may compare the total energy of different frequency samples against different thresholds. For example, the wind determiner unit 39 may determine that the magnitude of wind is high only when the total energy of a first sample(s) is greater than a first threshold and the total energy of a second sample(s) is greater than a second, different threshold.

The energy signature or shape of the wind may vary significantly with time. The time resolution of the spectral analyser 38 may therefore be defined so as to smooth out these short-term variations. Alternatively, the wind determiner unit 39 may determine the magnitude of wind based on the total energy of frequency samples at different time intervals. For example, the spectral analyser 38 may generate a first set of frequency samples at time T1, and a second set of frequency samples at time T2. The wind determiner unit 39 then sums or averages the energies of both sets of samples in order to determine the total energy.

A potential problem with the first method is that some real-life noises (e.g. thunder, surf, an overhead helicopter) may have energies contained within the predefined frequency range, and thus be mistaken for wind.

In a second method, the wind detect module 35 again determines a magnitude of wind using just one of the feedforward microphones 27. However, rather than determining the magnitude of wind based on the total energy of the frequency samples, the wind determiner unit 39 instead determines the magnitude of wind based on variations in the total energy with time.

As already noted, the energy signature of wind may vary significantly with time. By contrast, the energy signature of real-life noise (at these low frequencies) may vary comparatively little over the same timescale. Accordingly, the wind determiner unit 39 determines the magnitude of wind based on temporal variations in the total energy of the frequency samples.

The wind determiner unit 39 determines differences in the total energy of the samples at different time intervals. For example, the spectral analyser 38 may generate a first set of samples at time T1, and a second set of samples at time T2. The wind determiner unit 39 then determines differences in the energies of the first and second set of samples, and determines the magnitude of wind based on these differences.

The wind determiner unit 39 may determine a measure representative of the temporal variance of the total energy of the samples. For example, the wind determiner unit 39 may determine the sum of squared differences or the sum of absolute differences. The wind determiner unit 39 then compares the measure (e.g. sum of squares) against one or more thresholds in order to determine the magnitude of the wind. For example, the wind determiner unit 39 may determine that the magnitude of wind is low if the measure is less than a threshold, and high if the measure is greater than the threshold.

The wind detect module 35 may employ both the first method and the second method in order to determine more reliably the magnitude of wind. In this instance, the wind determiner unit 39 determines the magnitude of wind based on both the total energy of the samples and also temporal variations in the total energy. So, for example, the wind determiner unit 39 may determine that the wind is high only if the total energy of the samples is greater than a first threshold and the sum of squares of the differences in the total energies is greater than a second threshold.

In employing both the first method and the second method, the wind detect module 35 provides a more reliable determination of the magnitude of wind. Nevertheless, real-life noises having energies within the predefined frequency range may be short-lived, and thus be mistaken for wind.

In a third method, the wind detect module 35 determines a magnitude of wind using the feedforward microphones 27 of both ear cups 3,4.

At relatively low frequencies, where the majority of the energy from wind is contained, real-life noises will have a relatively long wavelength and are not therefore significantly altered by the headgear 1 or the human body. Accordingly, over the predefined frequency range (e.g. below 50 Hz), the two feedforward microphones 27 will detect real-life noises at similar energies and phases. However, when wind particles impact the diaphragms of the two microphones 27, they do so in a random way that is unique to each microphone. As a result, the wind manifests itself as different energies in the signals of the two microphones 27. The wind detect module 35 therefore exploits this behaviour in order to determine the magnitude of the wind.

The wind detect module 35 determines the magnitude of the wind based on a comparison of the two microphone signals. More particularly, the wind determiner unit 39 determines a magnitude of wind based on differences in the energies of the two microphone signals.

The wind determiner unit 39 may determine the magnitude of wind based on differences in the total energies of the frequency samples of the two signals. For example, the wind determiner unit 39 may determine that the magnitude of wind is low if a measure of the differences (e.g. sum of squares or sum of absolutes) is less than a threshold, and high if the measure is greater than a threshold. Alternatively or additionally, the wind determiner unit 39 may determine the magnitude of wind based on temporal variations in the differences in the energies of the two signals. For example, the spectral analyser 38 may generate a first set of samples (for both microphones) at time T1, and a second set of samples (again, for both microphones) at time T2. The wind determiner unit 39 may then determine a first difference value (e.g. sum of squares or sum of absolutes) based on differences in the energies of the first set of samples, and a second difference value based on differences in the energies of the second set of samples. The wind determiner unit 39 may then determine that the magnitude of wind is high only if both the first difference value and the second difference value are greater than a threshold.

The wind detect module 35 may use the third method together with one or both of the first method and the second method. For example, the wind determiner unit 39 may determine that the magnitude of wind is high only if (i) the total energy of the samples of one of the microphone signals is greater than a threshold (first method) and (ii) the difference in the total energies of the two microphone signals is greater than a further threshold (third method). In this way, the wind determiner unit 39 determines that the magnitude of wind is high only if (i) the low-frequency energy in at least one of the microphone signals is high and (ii) the low-frequency energies of the two microphone signals are sufficiently different. As a further example, the wind determiner unit 39 may determine that the magnitude of wind is high only if (i) the difference in the total energies of one of the microphone signals over a given time period is greater than a threshold (second method) and (ii) the differences in the total energies of the two microphone signals over the same time period is greater than a further threshold (third method). In this way, the wind determiner unit 39 determines that the magnitude of wind is high only if (i) the low-frequency energy in at least one of the microphone signals varies with time, and (ii) the low-frequency energies of the two microphone signals are sufficiently different at different times.

In a fourth method, the wind detect module 35 determines a magnitude of wind using two microphones. The first microphone is the feedforward microphone 27 of one of the ear cups, and the second microphone is either the feedback microphone 28 of the same ear cup or the feedforward microphone 27 of the opposite ear cup.

The wind determiner unit 39 determines a magnitude of wind based on the coherence of the two microphone signals. Coherence is a measure of the relationship between the two microphone signals, and may therefore be used to evaluate similarity. Any noise present in one of the microphone signals but not the other will result in a lower coherence value. For two microphones located in relatively close proximity, real-life noise will have a similar energy signature (albeit at potentially different amplitudes) in each of the microphone signals, at least at these low frequencies. By contrast, wind will have very different energies in the two microphone signals. Accordingly, the coherence of the two signals may be used to determine the magnitude of wind. For example, the wind determiner unit 39 may determine that the magnitude of wind is low if the coherence is greater than a threshold (i.e. the two signals are similar) and high if the coherence is less than the threshold (i.e. the two signals are dissimilar).

Again, the wind detect module 35 may use the fourth method together with one or more of the other methods. For example, the wind determiner unit 39 may determine that the wind is high only if (i) the total energy of at least one of the microphone signals is greater than a threshold (first method), and (ii) the coherence of the two microphones signals is less than a further threshold (fourth method).

The first microphone may be a feedforward microphone 27 and the second microphone may be a feedback microphone 28. This arrangement has the advantage that the two microphones 27,28 are located in close proximity, and thus real-life noise will result in substantially the same energy signature for both microphones, at low frequencies. Moreover, the feedback microphone 28 is isolated or shielded from the wind. As a result, incoherence in the two signals due to wind will be significantly increased. However, a potential disadvantage with this arrangement is that the speaker 25 of the ear cup 3,4 may generate sounds (e.g. sub-bass sounds) having energies within the predefined frequency range. As a result, the incoherence of the two signals will increase.

The first microphone may be a feedforward microphone 27 of one ear cup 3, and the second microphone may be a feedforward microphone 27 of the opposite ear cup 4. This arrangement then has the advantage that both microphones 27 are exposed to the wind. However, the microphones 27 are positioned further apart and thus differences in the two signals due to real-life noise will increase. Additionally, should the wearer grasp and manipulate one of the ear cups, the resulting noise will increase the incoherence of the two signals and may therefore be interpreted as wind. Furthermore, the sound generated by the air purifier 12 in the left ear cup 3 may differ from that generated by the air purifier 12 in the right ear cup 4, which again will increase the incoherence in the two signals.

So far reference has been made to determining a magnitude of wind. However, the wind detect module 35 may additionally or alternatively determine a direction of wind.

In a fifth method, the wind detect module determines a direction of wind using the two feedforward microphones 27.

The fifth method is essentially an expansion of the first method. The wind determiner unit 29 determines the total energy of the first microphone (e.g. left ear cup) and the total energy of the second microphone (e.g. second ear cup). The wind determiner unit 39 then determines a direction of wind based on a comparison of the two energies. For example, the wind determiner unit 39 may determine that the wind is coming from the left if the total energy of the first microphone is greater, and from the right if the total energy of the second microphone is greater. The wind determiner unit 39 then determines that the wind is coming from the front or rear if the total energy of the two microphones are the same or similar. In a further example, the wind determiner unit 39 may determine that the wind is a crosswind if the difference in the total energies of the two signals is greater than a threshold, and a headwind or tailwind if the difference is less than the threshold.

The wind detect module 35 may combine the fifth method with one or more of the previously described methods in order better determine the direction of wind. For example, the total energy of the first microphone might be greater than that of the second microphone, suggesting that the wind is coming from the left. However, the energy of the first microphone may be relatively constant with time (indicative of real-life noise), whereas the energy of the second microphone may be variable (indicative of wind). The wind determiner unit 39 may therefore determine the direction of wind based on (i) the total energies of the two microphone signals (fifth method) and (ii) temporal variations in the energies of the two microphone signals (third method). As a result, the wind detect module 35 may make a more reliable determination of the direction of wind.

In a sixth method, the wind detect module 35 determines a direction of wind using the feedforward and feedback microphones 27,28 of both ear cups 3,4.

The wind determiner unit 39 determines a magnitude of wind at each ear cup 3,4 based on the coherence of the signals of the feedforward and feedback microphones for that ear cup. The wind determiner unit 39 may additionally use one or more of the other methods described above to determine the magnitude of wind at each ear cup 3,4. The wind determiner unit 39 then determines the direction of wind based on a comparison of the magnitudes of wind. So, for example, the wind determiner unit 39 may determine that the wind is coming from the left if the magnitude of wind at the left ear cup 3 is greater, from the right if the magnitude of wind at the right ear cup 4 is greater, and from the front or rear if the magnitudes of wind for the two ear cups 3,4 are the same or similar.

It will be apparent from the above that the wind detect module 35 may employ different methods and/or permutations of methods in order to determine the magnitude and/or direction of wind. In the example methods described above, the wind detect module 35 determines whether the magnitude of wind is low or high, and/or whether the direction of wind is from the left, right or front/rear. However, as already noted, the wind detect module 35 may use other scales when determining the magnitude and/or direction of wind. This may be achieved, for example, through the use of multiple thresholds.

The headgear 1 has four microphones 27,28. However, as described above, the wind detect module 35 is capable of determining the magnitude and/or direction of wind using a fewer number of microphones. In particular, the wind detect module 35 is capable of determining the magnitude of wind using just one microphone, and the direction of wind using just two microphones.

The wind detect module 35 makes use of the ANC microphones 27,28 of the headgear 1. This then provides a cost-effective solution for controlling the flow rates of the air purifiers 12 in response to changes in wind. However, the headgear 1 may comprise additional or alternative microphones, which the wind detect module 35 may use to determine the magnitude and/or direction of wind. For example, the headgear 1 may comprise one or more telephony microphones. In particular, the headgear 1 may comprise a pair of telephony microphones on one or both of the ear cups 3,4. Pairs of telephony microphones may be placed in close proximity to one another to provide beamforming. As a result, the microphones, both of which are exposed to wind, are well-suited at detecting wind.

The headgear 1 comprises a pair of air purifiers 12. This arrangement has several advantages over say a single air purifier. For example, the weight of the headgear 1 is better balanced between the two ear cups 3,4. Additionally, a stream of purified air may be generated at a given flow rate by driving the electric motors 30 at lower speeds, which in turn reduces noise. Nevertheless, in spite of these advantages, the headgear 1 could conceivably comprise a single air purifier. The motor control unit 36 would continue to control the flow rate of the air purifier in response to changes in the magnitude of the wind. The motor control unit 36 may also control the flow rate of the air purifier in response to changes in the direction of the wind. For example, in response to a crosswind, the motor control unit 26 may increase the flow rate of the air purifier such that a stronger stream of purified air is directed at the wearer. Alternatively, the headgear 1 might include a butterfly valve or other means located at the outlet 43 of the nozzle 5, which is moved in order to change the direction in which the stream of purified air is discharged.

Whilst particular embodiments have thus far been described, it will be understood that various modifications may be made without departing from the scope of the invention as defined by the claims.

1. A headgear comprising an air purifier, a first microphone, a second microphone, and a control unit, wherein the control unit analyses a first signal output by the first microphone and a second signal output by the second microphone to determine a direction of wind, and the control unit controls a flow rate of the air purifier in response to the determined direction of wind.

2. The headgear as claimed in claim 1, wherein the headgear comprises a further air purifier and the control unit controls the relative flow rates of the air purifier and the further air purifier in response to the determined direction of wind.

3. The headgear as claimed in claim 2, wherein the air purifier is located on a first side of the headgear, the further air purifier is located on a second opposite side of the headgear, and the control unit, in response to determining that the direction of wind is from a side of the headgear, increases the relative flow rate of the air purifier located on the opposite, downstream side of the headgear.

4. The headgear as claimed in claim 2, wherein the air purifier generates a first flow of purified air, the further air purifier generates a second flow of purified air, the first flow and the second flow combine to generate a combined flow of purified air, and the direction of the combined flow is defined by the relative flow rates of the air purifier and the further air purifier.

5. The headgear as claimed in claim 4, wherein the headgear comprises a nozzle having a first inlet for receiving the first flow from the air purifier, a second inlet for receiving the second flow from the further air purifier, and an outlet for discharging the combined flow.

6. The headgear as claimed in claim 1 , wherein the control unit determines the direction of wind based on differences in the first signal and the second signal.

7. The headgear as claimed in claim 1 , wherein the control unit: transforms time samples of the first signal into one or more first frequency samples; transforms time samples of the second signal into one or more second frequency samples; and determines the direction of wind based on energies of the first frequency samples and the second frequency samples.

8. The headgear as claimed in claim 7, wherein the control unit determines the direction of wind based on differences in the energies of the first frequency samples and the second frequency samples.

9. The headgear as claimed in claim 8, wherein the control unit determines the direction of wind based on variations in the differences with time.

10. The headgear as claimed in claim 1 , wherein the control unit determines a coherence of the first signal and the second signal, and determines the direction of wind based on the coherence.

11. The headgear as claimed in claim 1 , wherein the control unit: transforms time samples of the first signal into one or more first frequency samples; transforms time samples of the second signal into one or more second frequency samples; and determines the direction of wind based on at least two of:
the energies of the first frequency samples and/or the second frequency samples;
variations in the energies of the first frequency samples and/or the second frequency samples with time;
differences in the energies of the first frequency samples and the second frequency samples; and
variations in the differences in the energies of the first frequency samples and the second frequency samples.

12. The headgear as claimed in claim 1 , wherein the control unit analyses the first signal and the second signal to determine a magnitude of wind, and the control unit controls the flow rate of the air purifier in response to the determined magnitude of wind and the determined direction of wind.

13. The headgear as claimed in claim 12, wherein the control unit: transforms time samples of the first signal into one or more first frequency samples; transforms time samples of the second signal into one or more second frequency samples; and determines the magnitude of wind and the direction of wind based on energies of the first frequency samples and the second frequency samples.

14. The headgear as claimed in claim 12, wherein the headgear comprises a further air purifier and the control unit controls the relative flow rates of the air purifier and the further air purifier in response to the determined magnitude of wind and the determined direction of wind.

15. The headgear as claimed in claim 14, wherein the air purifier is located on a first side of the headgear, the further air purifier is located on a second, opposite side of the headgear, and the control unit, in response to determining that the direction of wind is from a side of the headgear, increases the relative flow rate of the air purifier located on the opposite, downstream side of the headgear by an amount defined by the magnitude of the wind.

16. The headgear as claimed in claim 1 , wherein the headgear comprises a left ear cup and a right ear cup, the left ear cup comprises the first microphone, and the right ear cup comprises the second microphone.

17. The headgear as claimed in claim 16, wherein each ear cup comprises a speaker and an active noise cancellation unit, the active noise cancellation unit of the left ear cup comprises the first microphone, and the active noise cancellation of the right ear cup comprises the second microphone.

18. The headgear as claimed in claim 1 , wherein the headgear comprises a third microphone and a fourth microphone, the control unit analyses signals output by the four microphones to determine the direction of wind, the first and second microphones are feedforward microphones and the third and fourth microphones are feedback microphones.
